(19) United States
(12) Patent Application Publication
(10) Pub. No.: US 2021/0055417 A1
(43) Pub. Date: Feb. 25, 2021

(54) METHODS FOR GENERATING TREATMENT PRESCRIPTIONS BASED ON UAV-DERIVED PLANT HEIGHT DATA AND RELATED CROP MANAGEMENT SYSTEMS

(71) Applicant: CNH Industrial America LLC, New Holland, PA (US)

(72) Inventors: Andrew Brokaw, Elgin, IL (US); Hesam Abbassi, Chicago, IL (US); Panos Tamamidis, Mount Prospect, IL (US); Samrendra K. Singh, Westmont, IL (US)

(73) Assignee: CNH Industrial America LLC

(21) Appl. No.: 16/549,750

(22) Filed: Aug. 23, 2019

(51) Int. Cl. G01S 17/89; B64C 39/02; B64D 47/08; G01B 11/24; G01B 11/06

(52) U.S. Cl. CPC G01S 17/89; B64C 39/02; B64D 47/08; A01C 23/007; G01B 11/0608; B64C 2201/123; G01B 11/24

(57) ABSTRACT

In one aspect, a method for generating agricultural treatment prescriptions includes generating a pre-emergence field contour map for a field based on pre-emergence aerial data collected for the field, the pre-emergence field contour map being indicative of the ground surface topology of the field in a pre-emergence condition. The method also includes generating a post-emergence field contour map for the field based on post-emergence aerial data collected for the field, the post-emergence field contour map being indicative of a field topology of the field following plant emergence. In addition, the method includes identifying individual plant heights of the plants based at least in part on a comparison between the pre-emergence field contour map and the post-emergence field contour map, and determining a treatment prescription for applying one or more agricultural products to the field based at least in part on the individual plant heights.

### FIELD OF THE INVENTION

The present subject matter relates generally to systems and methods for automating aspects of crop production and management, and, more particularly, to methods for providing automated plant height measurements using unmanned aerial vehicles (UAVs) and for generating treatment prescriptions based on the UAV-derived plant height data, as well as related crop management systems.

### BACKGROUND OF THE INVENTION

In order to optimize yields, the agricultural industry is heavily reliant upon agricultural data. Historically, given the limited amount of data that was available, farmers often simply assumed that fields were essentially homogeneous across their entire areas. Because of this assumption, farm management was conducted in a way in which agricultural inputs (e.g., tillage, planting, fertilizer application, herbicide application, and other working of soil and crops) were applied at uniform rates over an entire field or set of fields. Technological developments, however, now allow crop production to be optimized by learning and responding to variations in soil conditions, as well as in other properties that commonly exist within any given agricultural field. By varying the inputs applied to a field to compensate for local variations or anomalies within the field, an agricultural producer can optimize crop yield and quality by providing the amount of input needed at a specific site. An additional benefit is the reduction of potential environmental damage or degradation due to, for example, erosion, pesticides, or herbicides. This management technique has become known as precision, site-specific, prescriptive, or spatially variable farming.

Recently, advancements in unmanned aerial vehicle (UAV) technologies have allowed UAVs to be used within certain aspects of the farming industry. For example, recent developments have been made in connection with using UAVs for the collection of field data. However, the use of UAVs in this manner is still an emerging technology area. As such, further improvements and refinements are necessary to allow for the integration of UAVs into modem crop management practices, particularly in relation to the collection and use of field data.

Accordingly, improved systems and methods for collecting and using aerial-based field data, including the use of UAVs in capturing such data, would be welcomed in the technology. For instance, systems and methods for providing automated plant height measurements using aerial-based data collected by UAVs and/or for using such data for crop management purposes would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for generating agricultural treatment prescriptions. The method includes generating, with a computing device, a pre-emergence field contour map for a field based on pre-emergence aerial data collected for the field, the pre-emergence field contour map being indicative of a ground surface topology of the field while the field is in a pre-emergence condition. The method also includes generating, with the computing device, a post-emergence field contour map for the field based on post-emergence aerial data collected for the field, the post-emergence field contour map being indicative of a field topology of the field following emergence of plants within the field. In addition, the method includes identifying, with the computing device, individual plant heights of the plants located within one or more portions of the field based at least in part on a comparison between the pre-emergence field contour map and the post-emergence field contour map, and determining, with the computing device, a treatment prescription for applying one or more agricultural products to the field based at least in part on the individual plant heights identified within the one or more portions of the field.

In another aspect, the present subject matter is directed to a crop management system. The system includes one or more unmanned aerial vehicles (UAVs) equipped with a sensor configured to capture aerial-based topology data associated with a field. The UAV(s) is configured to be flown across the field at differing times to allow the sensor to collect both pre-emergence topology data and post-emergence topology data for the field. The system also includes a controller configured to be communicatively coupled to the sensor. The controller is configured to generate a pre-emergence field contour map for the field based on the pre-emergence topology data received from the sensor, the pre-emergence field contour map being indicative of a ground surface topology of the field while the field is in a pre-emergence condition. The controller is also configured to generate a post-emergence field contour snap for the field based on post-emergence topology data received from the sensor, the post-emergence field contour map being indicative of a field topology of the field following emergence of plants within the field. In addition, the controller is configured to identify individual plant heights of the plants located within one or more portions of the field based at least in part on a comparison between the pre-emergence field contour map and the post-emergence field contour map the plant height profile, and determine a treatment prescription for applying one or more agricultural products to the field based at least in part on the individual plant heights identified within the one or more portions of the field.

These and other features, aspects and advantages of the present invention will become better understood with reference to the following description and appended claims. The accompanying drawings, which are incorporated in and constitute a. part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an example view of one embodiment of a crop management system in accordance with aspects of the present subject matter;

FIG. 2 illustrates a schematic view of another embodiment of a crop management system in accordance with aspects of the present subject matter;

FIG. 3 illustrates example views of various LAY passes made across a field to collect topology data related to the field in accordance with aspects of the present subject matter, including a pre-emergence UAV pass and two separate post-emergence UAV passes;

FIG. 4 illustrates an exemplary plot including height contour lines representing the topology data captured during the UAV passes shown in FIG. 3 in accordance with aspects of the present subject matter;

FIG. 5 illustrates a three-dimensional plot shown an example plant height profile for a field that can he generated using the topology data collected from the field in accordance with aspects of the present subject matter;

FIG. 6 illustrates an exemplary view of one embodiment of a prescription map representative of a treatment prescription for a field in accordance with aspects of the present subject matter; and

FIG. 7 illustrates a flow diagram of one embodiment of a method for method for generating agricultural treatment prescriptions in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to methods for providing automated plant height measurements using unmanned aerial vehicles (UAVs) and for generating treatment prescriptions based on the UAV-derived plant height data, as well as related crop management systems. Specifically, in several embodiments, a sensor-equipped UAV may be flown across a field to collect topology data at various different times before and after the emergence of plants. For instance, the UAV may make one or more pre-emergence passes across the field to collect pre-emergence topology data associated with the ground surface topology of the field prior to the emergence of plants. Thereafter, the UAV may make numerous post-emergence passes across the field to collect post-emergence topology data associated with the field topology following the emergence of plants within the field. For instance, the post-emergence passes may be scheduled in a periodic manner (e.g., every 10 days, 20 days, 30 days, etc.) such that field topology data is collected at various different times across the growth cycle of the plants.

The pre-emergence and post-emergence data collected by the sensor-equipped UAV may then be analyzed to determine the height profile of the entire field. For instance, the ground surface topology represented by the pre-emergence data may be used as a baseline topology reference for assessing the post-emergence topology data. Specifically, the ground surface topology may be subtracted from the field topology represented by the post-emergence data to determine a plant height profile across the field. Thereafter, by knowing the location of each plant within the field (e.g., based on a crop grid or planting map), the height of each individual plant may be determined by overlaying or identifying the plant locations within the plant height profile.

Moreover, in accordance with aspects of the present subject matter, a treatment prescription may be generated that provides for the localized treatment of specific areas within the field with one or more agricultural products (e.g., fertilizer, herbicides, pesticides, etc.) based on the plant height data. Specifically, in several embodiments, the treatment prescription may specify that an agricultural product(s) only be applied to areas within the field that exhibit lower plant heights. Alternatively, the treatment prescription may specify that varying amounts of an agricultural product(s) be applied to the field based on the plant height profile, with largest amount of the agricultural product(s) being applied to the areas with lower plant heights.

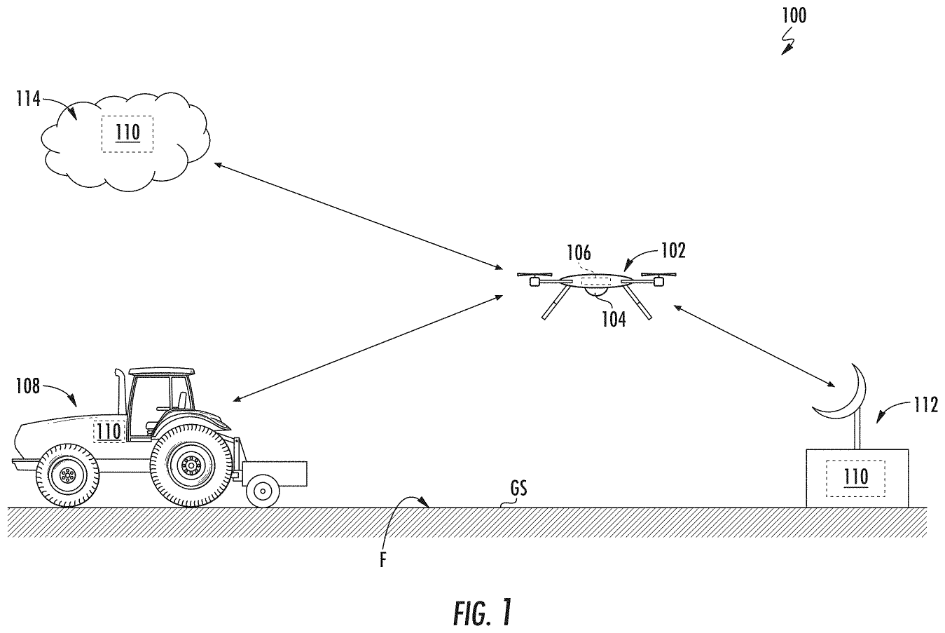

Referring now to the drawings, FIG. 1 illustrates an example view of one embodiment of a crop management system 100 in accordance with aspects of the present subject matter. As shown in FIG. 1, the system 100 may generally include one or more unmanned aerial vehicles (UAVs) 102 configured to be flown over a field F to allow aerial-based data to he collected via an associated sensor(s) 104 supported on the UAV(s) 102. Specifically, in several embodiments, the UAV(s) 102 may be flown across the field F to allow the sensor(s) 104 to collect aerial-based data associated with a topology or height contour for the field F. For instance, as will be described below, the UAV(s) 102 may be configured to make one or more passes across the field F while the field F is in a pre-emergence condition (e.g., prior to the performance of a planting operation within the field F or following the performance of a planting operation, but prior to emergence of the plants) to allow the sensor(s) 104 to collect pre-emergence aerial-based data associated with the topology of the ground surface GS of the field F. Additionally, the UAV(s) 102 may be configured to make one or more passes across the field F while the field F is in a post-emergence condition to allow the sensor(s) 104 to collect post-emergence aerial-based data associated with the topology of the field F following the emergence plants.

As will be described below, the pre-emergence and post-emergence data collected by the sensor(s) 104 may be used to generate corresponding pre-emergence and post-emergence field contour maps, respectively, that are indicative of the topology of the field F in such differing conditions. In such an embodiment, the pre-emergence field contour map may be used a reference or baseline topology for determining the height profile of the plants across the field F at various different times during the growth cycle of the plants. For instance, the UAV(s) 102 may be periodically flown across the field F (e.g., every 10 to 30 days) to allow one or more sets of post-emergence aerial data to be collected at numerous different times along the growth cycle of the plants, thereby allowing a corresponding number of post-emergence field contour maps to be generated. The field topology represented by each post-emergence field contour map may then be compared to the ground surface topology represented by the pre-emergence field contour map to calculate a height profile of the plants across the field F at each corresponding point along the growth cycle. Each height profile may, in turn, be analyzed with an associated crop grid or planting map for the field F (e.g., geo-referenced planting data providing the location of each plant with the field F) to determine the independent plant height of each plant with the field F. Such plant-specific height data may then be used to generate localized treatment prescriptions for applying one or more agricultural products to the field F.

As will be described in greater detail below, in addition to the sensor(s) 104, the UAV(s) 102 may also support one or more additional components, such as an on-board computing device or controller 106. In general, the UAV controller 106 may be configured to control the operation of the UAV(s) 102, such as by controlling the propulsion system (not shown) of the UAV(s) 102 to cause the UAV(s) 102 to be moved relative to the field F. For instance, in one embodiment, the UAV controller 106 may be configured to receive flight plan data associated with a proposed flight plan for the UAV(s) 102. such as a flight plan selected such that the UAV(s) 102 makes one or more passes across the field in a manner that allows the sensor(s) 104 to capture aerial-based topology data across the entire field F (or at least across the portion of the field F that will he planted or that has already been planted). Based on such data, the UAV controller 106 may automatically control the operation of the UAV(s) 102 such that the UAV(s) 102 is flown across the field F according to the proposed flight plan to allow the desired data to be collected by the sensor(s) 104.

It should be appreciated that the UAV(s) 102 may generally correspond to any suitable aerial vehicle capable of unmanned flight, such as any UAV capable of controlled vertical, or nearly vertical, takeoffs and landings. For instance, in the illustrated embodiment, the UAV(s) 102 corresponds to a quadcopter. However, in other embodiments, the UAV(s) 102 may correspond to any other multi-rotor aerial vehicle, such as a tricopter, hexacopter, or octocopter. In still further embodiments, the UAV(s) 102 may be a single-rotor helicopter, or a fixed wing, hybrid vertical takeoff and landing aircraft.

Moreover, in certain embodiments, the disclosed system 100 may also include one or more agricultural vehicles 108 configured to perform a treatment operation during which one or more agricultural products (e.g., fertilizers, herbicides, pesticides, and/or the like) are applied to the field. For instance, the agricultural vehicle(s) 108 may correspond to an agricultural sprayer, such as a self-propelled sprayer or a towed sprayer. Alternatively, the vehicle(s) 108 may correspond to any other suitable vehicle configured to apply or deliver an agricultural product(s) to the field, such as a granular fertilizer applicator, etc. As indicated above, the system 100 may allow for a localized treatment prescription(s) to be generated based on the plant height data collected by the UAV(s) 102. In such instances, during the performance of a treatment operation, the agricultural vehicle(s) 108 may, for example, be controlled to allow an agricultural product(s) to be applied to specific areas within the field based on the requirements of the localized treatment prescription(s)

Additionally, as shown in FIG. 1, the disclosed system 100 may also include one or more remote computing devices or controllers 110 separate from or remote to the UAV(s) 102. In several embodiments, the remote controller(s) 110 may be communicatively coupled to the UAV controller 106 (e.g., via a wireless connection) to allow data to be transmitted between the UAV 102 and the remote controller(s) 110. For instance, in one embodiment, the remote controller(s) 110 may be configured to transmit instructions or data to the UAV controller 106 associated with the desired flight plan across the field F. Similarly, the UAV controller 106 may be configured to transmit or deliver the data collected by the sensor(s) 104 to the remote controller(s) 110.

It should be appreciated that the remote controller(s) 110 may correspond to a stand-alone component or may be incorporated into or form part of a separate component or assembly of components. For example, in one embodiment, the remote controller(s) 110 may form part of a base station 112. In such an embodiment, the base station 112 may be disposed at a fixed location, such as a farm building or central control center, which may be proximal or remote to the field F, or the base station 112 may be portable, such as by being transportable to a location within or near the field F. In addition to the base station 112 (or an alternative thereto), the remote controller(s) 110 may form part of an agricultural vehicle, such as the agricultural vehicle 108 described above (e.g., a sprayer, granular fertilizer applicator, etc.). For instance, the remote controller(s) 110 may correspond to a vehicle controller provided in operative association with the agricultural vehicle 108 and/or an implement controller provided in operative association with a corresponding implement of the vehicle 108. In other embodiments, the remote controller(s) 110 may correspond to or form part of a remote cloud-based computing system 114. For instance, as shown in FIG. 1, the remote controller(s) 110 may correspond to or form part of a cloud computing system 114 located remote to the field F.

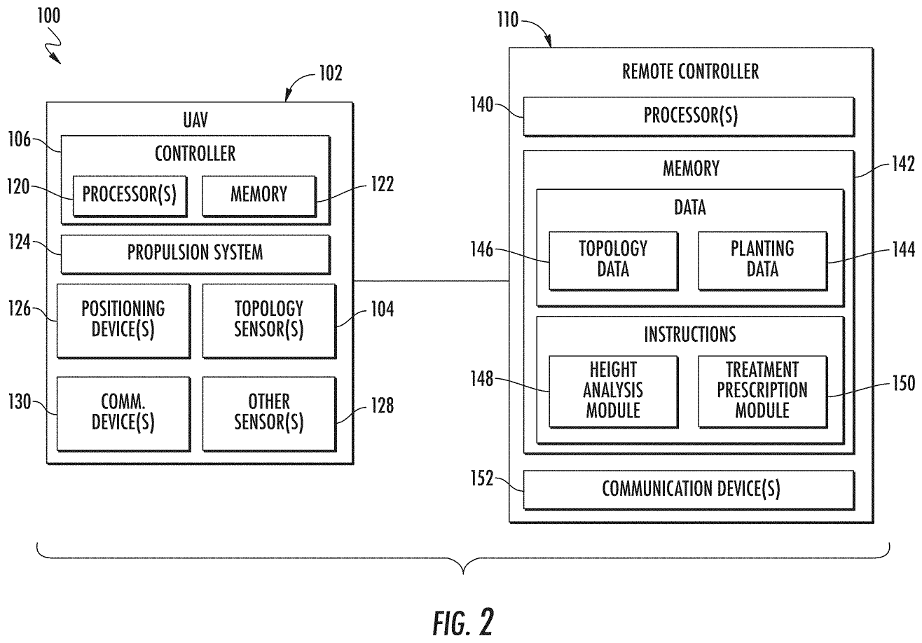

Referring now to FIG. 2, a schematic view of another embodiment of a crop management system 100 is illustrated in accordance with aspects of the present subject matter. In general, the system 100 shown in FIG. 2 will be described with reference to an example implementation of the system components illustrated in FIG. 1, such as the UAV 102 and the remote controller 110. However, it should be appreciated that, in other embodiments, the disclosed system 100 may have any other suitable system configuration or architecture and/or may incorporate any other suitable components and/or combination of components that generally allow the system 100 to function as described herein.

As shown, the system 100 may include one or more UAVs, such as the UAV 102 described above with reference to FIG. 1. In general, the UAV 102 may include and/or be configured to support various components, such as one or more sensors, controllers, and propulsion systems. For instance, as indicated above, the UAV 102 may be provided in operative association with one or more topology sensors 104 configured to capture or collect data associated with the topology or height contour of the field over which the UAV 102 is being flown. In this regard, the topology sensor(s) 104 may correspond to any suitable sensor(s) or sensing device(s) capable of detecting the topology or height contour of the field. For instance, in one embodiment, the sensor(s) 104 may comprise one or more vision-based sensors, such as one or more Light Detection and Ranging (LIDAR) devices and/or one or more cameras. A LIDAR device may, for example, may be used to generate a three-dimensional point cloud as the UAV 102 flies across the field that includes a plurality data points representing the topology or height contour of the field. Alternatively, a three-dimensional camera (e.g., a stereographic camera) may be used to generate three-dimensional images as the UAV 102 flies across the field that depict the topology or height contour of the field.

Additionally, as indicated above, the UAV may also include a controller 106. In general, the UAV controller 106 may correspond to any suitable processor-based device(s), such as a computing device or any combination of computing devices. Thus, in several embodiments, the UAV controller 106 may include one or more processor(s) 120 and associated memory device(s) 122 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 122 of the UAV controller 106 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 122 may generally be configured to store suitable computer-readable instructions that, when implemented by the processor(s) 120, configure the UAV controller 106 to perform various computer-implemented functions. It should be appreciated that the UAV controller 106 may also include various other suitable components, such as a communications circuit or module, a network interface, one or more input/output channels, a data/control bus and/or the like.

In several embodiments, the UAV controller 106 may be configured to automatically control the operation of a propulsion system 124 of the UAV 102. For instance, as indicated above, the UAV controller 106 may be configured to automatically control the propulsion system 124 in a manner that allows the UAV 102 to be flown across a field according to a predetermined or desired flight plan. In this regard, the propulsion system 124 may include any suitable components that allow for the trajectory, speed, and/or altitude of the UAV 102 to be regulated, such as one or more power sources (e.g., one or more batteries), one or more drive sources (e.g., one or more motors and/or engines), and one or more lift/steering sources (e.g., propellers, blades, wings, rotors, and/or the like).

Additionally, as shown in FIG. 2, the UAV 102 may also include a positioning device 126. In one embodiment, the positioning devices) 126 may be configured to determine the exact location of the UAV 102 within the field using a satellite navigation position system (e.g. a GPS system, a Galileo positioning system, the Global Navigation satellite system (GLONASS), the BeiDou Satellite Navigation and Positioning system, and/or the like). In such an embodiment, the location determined by the positioning device(s) 126 may be transmitted to the UAV controller 106 (e.g., in the form coordinates) and stored within the controller's memory for subsequent processing and/or analysis. By continuously monitoring the location of the UAV 102 as a pass is being made across the field, the sensor data acquired via the sensor(s) 104 may be geo-located within the field. For instance, in one embodiment, the location coordinates derived from the positioning device(s) 126 and the sensor data generated by the sensor(s) 104 may both be time-stamped. In such an embodiment, the time-stamped data may allow the sensor data to be matched or correlated to a corresponding set of location coordinates received or derived from the positioning device(s) 126, thereby allowing a field contour map to be generated that geo-locates the monitored field topology or height contour across the entirety of the field.

It should be appreciated that the UAV 102 may also include any other suitable components. For instance, in addition to the topology sensor(s) 104, the UAV 102 may also include various other sensors 128, such as one or more inertial measurement units for monitoring the orientation of the UAV 102 and/or one or more altitude sensors for monitoring the position of the UAV 102 relative to the ground. Moreover, the UAV 102 may include a communications device(s) 130 to allow the UAV controller 106 to be communicatively coupled to one or more other system components. The communications device 130 may, for example, be configured as a wireless communications device (e.g., an antenna or transceiver) to allow for the transmission of wireless communications between the UAV controller 106 and one or more other remote system components.

As shown in FIG. 2, the system 100 may also include one or more computing devices or controllers remote to the UAV 102, such as the remote controller(s) 110 described above with reference to FIG. 1. In general, the remote controller(s) 110 may be configured to be in communication with one or more components of the UAV 102 to allow data to be transferred between the UAV 102 and the remote controller(s) 110, such as sensor data collected via the topology sensor(s) 104. As indicated above, the remote controller(s) 110 may correspond to a stand-alone component or may be incorporated into or form part of a separate component or assembly of components. For example, the remote controller(s) 110 may be incorporated into or form part of a base station 112 and/or a cloud computing system 114. In addition, (or as alternative thereto), the remote controller(s) 110 may correspond to a component of an agricultural vehicle 108 and/or an associated implement towed by the vehicle 108, such as by corresponding to a vehicle controller and/or an implement controller.

Similar to the UAV controller 106, the remote controller(s) 110 may be configured as any suitable processor-based device(s), such as a computing device or any combination of computing devices. As such, the remote controller(s) 110 may include one or more processor(s) 140 and associated memory device(s) 142 configured to perform a variety of computer-implemented functions. The memory device(s) 142 may generally be configured to store suitable computer-readable instructions that, when implemented by the processor(s) 140, configure the remote controller(s) 110 to perform various computer-implemented functions. It should be appreciated that the remote controller(s) 110 may also include various other suitable components, such as a communications circuit or module, a network interface, one or more input/output channels, a data/control bus and/or the like.

In one embodiment, the memory 142 of the remote controller(s) 110 may include one or more databases for storing crop management information. For instance, as shown in FIG. 2, the memory 142 may include a planting database 144 storing planting data associated with a crop grid or planting map for the field being managed. For instance, following a planting operation, a crop grip may be transmitted or communicated to the remote controller(s) 110 that includes geo-referenced planting data providing the location of each plant with the field. As generally understood, crops are often planted in discrete crop rows, with a given row spacing between rows. Additionally, within each row, seeds are typically planted with a given seed spacing. Accordingly, the planting data may, for example, include data directly associated with the location of each seed within the field (e.g., the exact GPS coordinates of each seed within the field) or data that allows the locations of each seed within the field to be determined or calculated (e.g., the locations/heading of each row and the associated seed spacing).

Additionally, as shown in FIG. 2, the memory 142 may include a topology database 146 storing data received from the topology sensor(s) 104. As noted above, the topology sensors(s) 104 may be used to capture data indicative of the height contour or topology of the field being managed at various different points in time, For instance, topology data may be captured while the field is in a pre-emergence condition (e.g., prior to a seed planting operation in the field or following such operation but prior to emergence of the plants). In such instance, the topology database 146 may be used to store the pre-emergence data collected by the topology sensor(s) 104, which may be indicative of the topology of the bare ground surface. For example, the pre-emergence data may be stored as a pre-emergence field contour map that maps or geo-locates the ground surface topology across the field while the field is in a pre-emergence condition. Additionally, topology data may be captured following emergence of the plants, such as at numerous different times during the growth cycle of the plants. Accordingly, the topology database 146 may also be used to store the post-emergence data collected by the topology sensor(s) 104, which may be indicative of the topology of the field at the various different growth cycle times. For instance, the post-emergence data may be stored within the topology database 146 as a plurality of different datasets, with each dataset corresponding to the field topology data associated with a respective time at which data was collected for the field. In such an embodiment, each dataset may be stored, for example, as a post-emergence field contour map that maps or geo-locates the corresponding field topology across the field.

It should be appreciated that, as used herein, a “map” may generally correspond to any suitable dataset that correlates data to various locations within a field. Thus, for example, a map may simply correspond to a data table that correlates field contour or topology data to various locations within the field or may correspond to a more complex data structure, such as a geospatial numerical model that can be used to identify variations in the topology data and classify such variations into geographic zones or groups, which may, for instance, then be used to generate a graphically displayed map or visual indicator and/or to a provide a zone-specific or area-specific analysis of the topology data.

Referring still to FIG. 2, in several embodiments, the instructions stored within the memory 142 of the controller 110 may be executed by the processor(s) 140 to implement a height analysis module 148. In general, the height analysis module 148 may be configured to analyze the topology data received from the topology sensor(s) 104 to allow the remote controller(s) 110 to calculate the actual heights of the plants within the field. For instance, in several embodiments, the height analysis module 148 may be configured to determine or calculate a “height profile” of the plants within the field using the pre-emergence and post-emergence data collected by the topology sensor(s) 104. Specifically, in one embodiment, the height analysis module 148 may use the ground surface topology represented by the pre-emergence field contour map as a baseline or reference topology for analyzing the height profile of the plants. In such an embodiment, the field topology represented by each post-emergence field contour map may be compared to the pre-emergence field contour map to determine the height profile associated with such post-emergence dataset. For example, the corresponding height profile may be determined by calculating a difference between the field topology represented by the associated post-emergence field contour map and the ground surface topology represented by the pre-emergence field contour map. The resulting “height profile” for the field may then be stored within the memory 142 of the remote controller(s) 110 for subsequent processing and/or analysis.

Thereafter, by analyzing the calculated height profile in combination with the planting data stored within the planting database 144, the height analysis module 148 may determine the individual height of each plant within the field. For instance, the geo-referenced crop grid or planting map stored within the planting database 144 may be overlaid or otherwise analyzed together with the calculated height profile for the field to determine the exact distance or height between the post-emergence field contour map and the pre-emergence field contour map at each respective plant location. By performing a plant specific analysis for each post-emergence dataset, the individual heights of each plant may be determined at each point across the growth cycle at which data was collected. The individual plant heights may then be stored within the controller's memory 142 for subsequent processing and/or analysis. In addition, the individual growth rates for each respective plant within the field (e.g., as determined based on the height differentials between different post-emergence datasets) may be stored within the controller's memory 142 for subsequent processing and/or analysis.

Moreover, as shown in FIG. 2, the instructions stored within the memory 141 of the remote controller(s) 110 may also be executed by the processor(s) 140 to implement a treatment prescription module 150. In general, the treatment prescription module 150 may be configured to determine a localized or zone-specific treatment plan for the field being managed based on the plant height data provided by the height analysis module 148. Specifically, the treatment prescription module 150 may analyze the plant height data to identify specific zones or areas-of-interest (AOIs) within the field that require treatment due to the plant heights within such AOIs being lower than the plant heights within other areas of the field. For example, the treatment prescription module 150 may analyze the individual heights of the plants to characterize or categorize the plant height profile across the field, such as by grouping plants together within the field that have similar heights (e.g., within a certain height range) or based on any other suitable statistical analysis. The specific areas within the field represented by plant groupings having lower plant heights (e.g., as determined based on an average plant height across the field or according to any other statistical parameter) may then be identified as AOIs for the localized application of one or more agricultural products.

In one embodiment, the localized treatment prescription developed by the treatment prescription module 150 may differentiate between which portions of the field are to be treated with agricultural products based on the plant height data. For instance, the treatment prescription module 150 may prescribe that only AOIs associated with plants of lower heights are to be treated with one or more agricultural products, such as a fertilizer treatment, thereby eliminating the need to treat the entire field. In addition to differentiating between the specific areas within the field requiring treatment (or as an alternative thereto), the localized treatment prescription may prescribe varying amounts of agricultural product to be applied to the field based on the plant height data. For instance, the localized treatment prescription may indicate that the plant groupings or AOIs associated with the lowest plant heights are to be treated with the largest amount of fertilizer or nutrients. In such an embodiment, the prescribed amount of fertilizer or nutrients to be applied across other portions of the field may, for example, be incrementally decreased with increasing levels of plant heights for other identified plant groupings or AOIs.

As shown in FIG. 2, the remote controller(s) 110 may also include or be coupled to a communications device(s) 152 to allow the controller(s) 110 to be communicatively coupled to one or more other system components. For instance, similar to the UAV communications device 130 described above, the communications device 152 may be configured as a wireless communications device (e.g., an antenna or transceiver). In such an embodiment, data (e.g., sensor data, flight plan data, and/or the like) may, for example, be transmitted wirelessly between the remote controller(s) 110 and the UAV 102, as desired.

It should be appreciated that, although the various control functions and/or actions were generally described above as being executed by one of the controllers of the system (e.g., the UAV controller 106 or the remote controller(s) 110, such control functions/actions may generally be executed by either of such controllers 106, 110 and/or may be distributed across both of the controllers 106, 110. For instance, in an alternative embodiment, the height analysis module 148 may be executed by the UAV controller 106 to assess the topology data collected by the sensor(s) 104. Similarly, in another alternative embodiment, the operation of the UAV 102 (e.g., the operation of the propulsion system 124) may be controlled by the remote controller(s) 110 as opposed to the UAV controller 106.

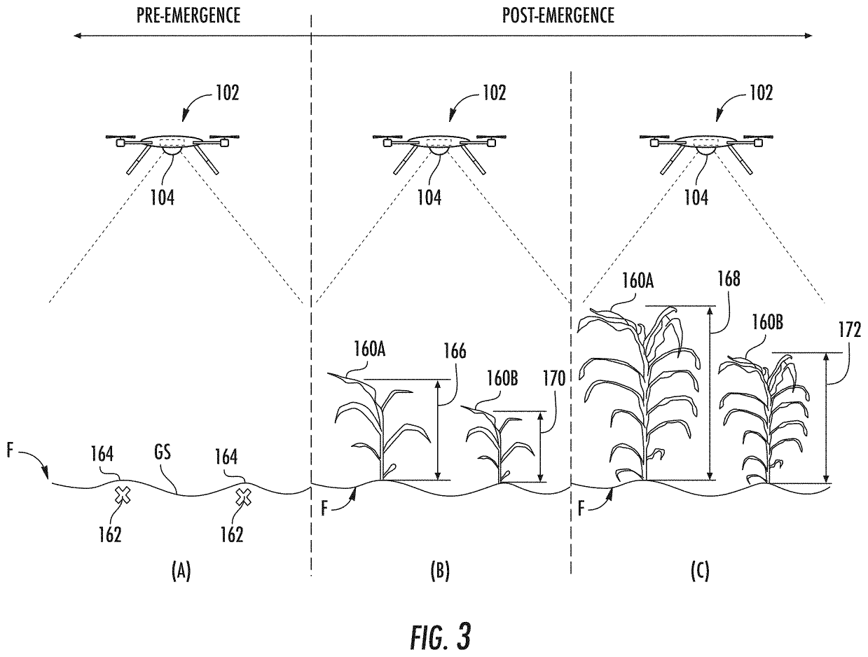

Referring now to FIG. 3, an example view of a UAV 102 making several different passes over the same portion of a field F to collect topology data associated with such portion of the field F is illustrated in accordance with aspects of the present subject matter. Specifically, FIG. 3 illustrates the UAV 102 making an initial pass A when the field F is in a pre-emergence condition. Additionally, FIG. 3 illustrates the UAV 102 making two subsequent passes B, C following emergence of the plants 160 within the field F, with the first post-emergence pass B being performed at a first time during the growth cycle of the plants 160 and the second post-emergence pass B being performed at a subsequent, second time during the growth cycle of the plants 160.

As shown in FIG. 3, during the initial pre-emergence pass A, the UAV 102 may be flown across the field F to capture topology data (via the topology sensor(s) 104) that is indicative of the topology or height contour of the ground surface GS of the field F. As indicated above, such pre-emergence data may be used to create a pre-emergence field contour map representing the ground surface topology. In the illustrated embodiment, the pre-emergence pass A is shown as being made following the planting of seeds 162 within the field F. Thus, the ground surface topology incorporates various surface features resulting from the previous planting operation, such as surface mounds 164 resulting from the closing of the furrows opened for deposition of the seeds. In such instance, the pre-emergence data captured by the topology sensor(s) 104 and corresponding pre-emergence field contour map may incorporate such variations in the ground surface contour. However, as indicated above, the UAV 102 may also be configured to make one or more pre-emergence passes prior to a planting operating being performed within the field F.

Following emergence of the plants 160 within the field F, the UAV 102 may then make any number of passes across the field F to capture post-emergence data indicative of the topology or height contour of the field F inclusive of the emerged plants 160. As indicated above, it may be desirable for the UAV 102 to make multiple post-emergence passes across the field F at different times during the growth cycle of the plants 160. For instance, the UAV 102 may be configured to make periodic post-emergence passes across the field F at predetermined intervals (e.g., every 10 days, 20 days, 30 days, etc.). Such periodic post-emergence passes allow field topology data to be captured that can be used to assess the growth rate of the plants 160 between successive passes.

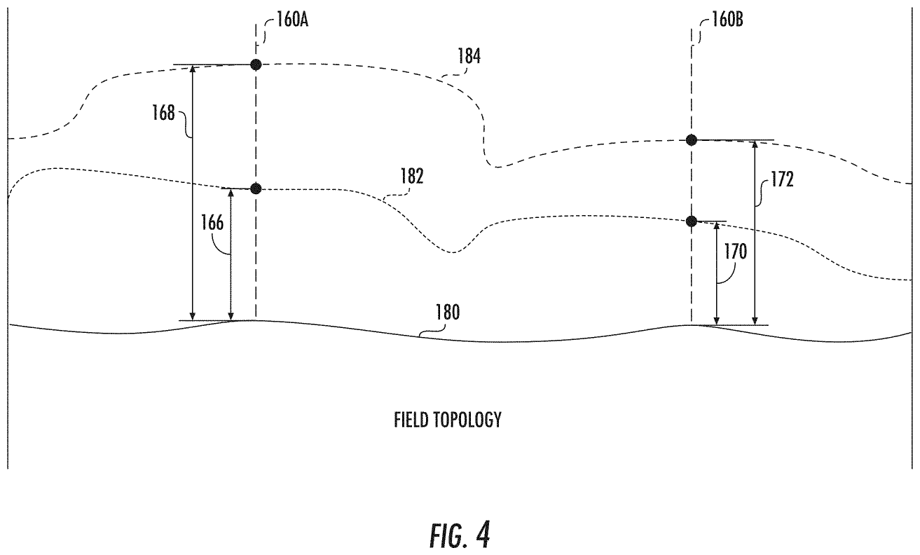

The two post-emergence passes B, C, shown in FIG. 3 provide examples of periodic passes that can be made by the UAV 102 following emergence of the plants 160. The first post-emergence pass B was made during an earlier stage of the growth cycle to allow field topology data to be captured at such earlier stage. Thereafter, the second post-emergence pass B was made at a later stage of the growth cycle to allow field topology data to be captured at such later stage. As will be described below with reference to FIG. 4, the field topology data captured during each post-emergence pass B, C can then be analyzed in combination with the ground surface topology data to determine the height of each plant 160 at each stage of the growth cycle.

As shown in the example of FIG. 3, a height differential exists between the plants 160 that can be detected via the topology data provided by the sensor(s) 104. Specifically, the topology data may indicate that a first plant 160A within the field has a first height 166 at the time of the first pre-emergence pass B and a second taller height 168 at the time of the second pre-emergence pass C. Additionally, the topology data may indicate that a second plant 1603 within the field has a third height 170 at the time of the first pre-emergence pass B (which is less than the first height 166 of the first plant 160A) and a fourth taller height 172 at the time of the second pre-emergence pass C (which is less than the second height 168 to the first plant 160A). Accordingly, by comparing the height data collected during each pass, it may be determined that the growth of the second plant 160B is lagging behind as compared to the growth of the first plant 160A, which may necessitate localized treatment of the plant 1603 (e.g., with fertilizer). Additionally, by analyzing the height data collected across the differing passes, the growth rate of each plant 160A, 160B may be determined and assessed.

It should be appreciated that, when collecting the topology data, the UAV 102 may, in one embodiment, be configured to be flown across the field F at the same altitude for each pass, thereby allowing the topology data collected by the sensor(s) 104 to be referenced from a given altitude. In addition to such fixed altitude flights (or as an alternative thereto), the UAV(s) 102 may be flown over one or more reference features having a known height(s) (e.g., one or more fixed posts or other stakes having a predetermined height(s)) to allow the sensor(s) 104 to capture reference height data for the topology dataset being collected.

Referring now to FIG. 4, an exemplary plot of the topology data collected during the three field passes A, B, C described above with reference to FIG. 3 is illustrated in accordance with aspects of the present subject matter. Specifically, the exemplary plot illustrates a pre-emergence field contour line 180 representative of the ground surface topology detected during the pre-emergence pass A, as well as first and second post-emergence field contour lines 182, 184 representative of the field topology detected during the first and second post-emergence passes B, C, respectively.

As indicated above, the ground surface topology detected during the pre-emergence pass A may be used as a reference or baseline field contour map for evaluating both the height profile of the field, as well as the individual heights of the plants within the field. For instance, the height profile of the field at the time of the first post-emergence pass B can be determined by calculating the height differential between the pre-emergence field contour line 180 and the first post-emergence field contour line 182 at each location across the entire field. Similarly, the height profile of the field at the time of the second post-emergence pass C can be determined by calculating the height differential between the pre-emergence field contour line 180 and the second post-emergences field contour line 184 at each location across the entire field.

Additionally, by knowing the exact location of each plant within the field (e.g., by referencing the associated crop grid or planting map), individual plant heights may be calculated for the plants by determining the height differential between the pre-emergence field contour line 180 and each post-emergence field contour line 182, 184 at the various plant locations. For instance, in the exemplary plot of FIG. 4, the corresponding locations of the first and second plants 160A, 106B shown in FIG. 3 are represented by first and second vertical lines 160A, 160B, respectively. Thus, as shown in FIG. 3, the height 166, 168 of the first plant 160A at the time of each post-emergence pass B, C may be determined by calculating the height differential between the pre-emergence field contour line 180 and each post-emergence field contour line 182, 184 at such plant location. Similarly, the height 170, 172 of the second plant 160B at the time of each post-emergence pass B, C may be determined by calculating the height differential between the pre-emergence field contour line 180 and each post-emergence field contour line 182, 184 at such plant location.

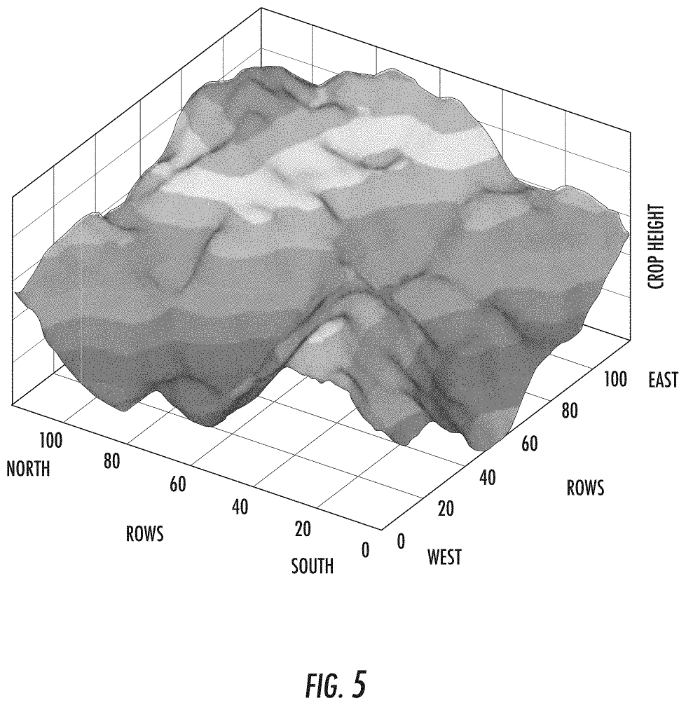

An exemplary plot of a three-dimensional contour map representative of the height profile of a field following the emergence of plants is illustrated in FIG. 5. As shown, the plot illustrates height profile data across a plurality of crop rows, with the height profile data corresponding to the height differential determined between the detected ground surface topology for the field and the subsequently detected field topology during a corresponding post-emergence UAV pass. Since the height profile is representative of the field topology across the entire field, the profile incorporates topology data at each location with the field, including the locations of the plants and the locations between adjacent plants. However, as indicated above, geo-referenced planting data associated with the locations of each plant within the field may be used when analyzing the determined height profile of the field, thereby allowing the height of each individual plant to be determined. As such, it should be appreciated that the individual plant heights may be represented by individual data points (or individual collections of data points) spaced apart across the height profile according to the row/seed spacing associated with the planting map.

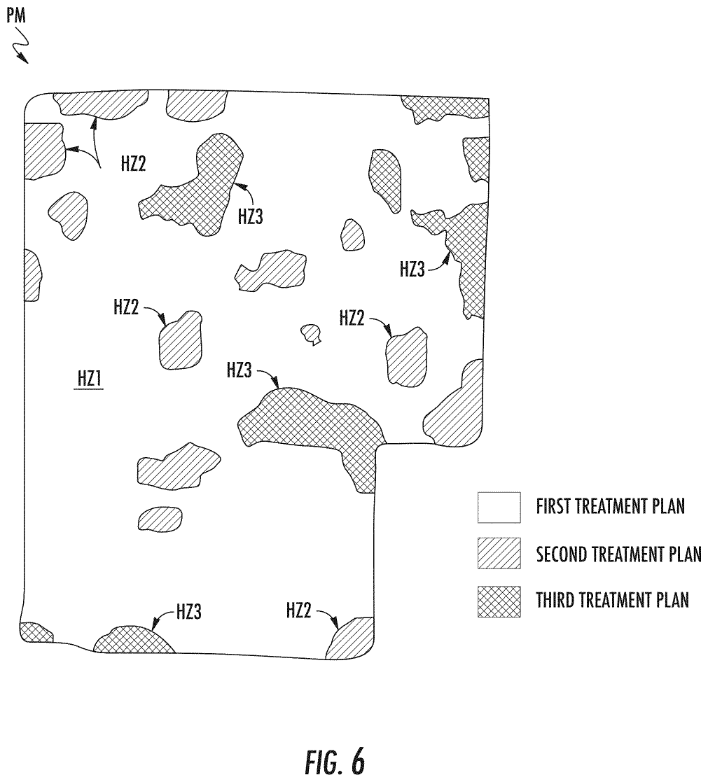

Referring now to FIG. 6, an example treatment prescription map (PM) is illustrated in accordance with aspects of the present subject matter. As shown, the prescription PM identifies different areas-of-interest or plant height zones within the field F and which treatment plan should be used within each height zone. In the illustrated embodiment, the prescription PM indicates that the field F includes three plant height zones, namely a first height zone (HZ1) across which the plants have individual plant heights that are at or above the average plant height for the field F, a second height zone (HZ2) across which the plants have individual plant heights that fall within a height range from the average plant height for the field F to 10% less than the average plant height, and a third height zone (HZ3) across which the plants have individual plant heights that fall within a height range from 10% less than the average plant height for the field F to 20% less than the average plant height.

Additionally, as shown in FIG. 6, an individualized treatment plan has been created for each height zone to address the varying height profiles across the differing height zones. In several embodiments, the individualized treatment plans may be selected such that more fertilizer, nutrients, and/or other appropriate agricultural products are applied to the height zones with plants having shorter plant heights. For instance, in the illustrated embodiment, first, second, and third treatment plans (TP1, TP2, TP3) have been created for the respective first, second, and third height zones HZ1, HZ2, HZ3. Given that the plants within the third height zone HZ3 currently exhibit the shortest plant heights, the third treatment plan TP3 may correspond to the most aggressive treatment plan, such as by requiring that the largest amount of fertilizer, nutrients, and/or other appropriate agricultural products to be applied across such zone HZ3. Similarly, although the plants within the second height zone HZ2 currently exhibit greater plant heights than the plants within the third height zone HZ3, such plant heights are still less than the average plant height across the field F. As such, while the second treatment plan TP2 may correspond to a less aggressive treatment plan than the third treatment plan TP3, such treatment plan may still require that a given amount of amount of fertilizer, nutrients, and/or other appropriate agricultural products be applied across the associated height zone HZ2. In contrast, since the plants within the first height zone HZ1 currently exhibit plant heights that are at or above the average plant height for the field, the first treatment plan TP1 may correspond to the least aggressive treatment plan, such as by requiring that the smallest amount of fertilizer, nutrients, and/or other appropriate agricultural products to he applied across such zone HZ1. Alternatively, given the favorable growth rate of the plants within the first height zone HZ1, the first treatment plan TP1 may correspond to an optional treatment plan or may correspond to a “No Treatment Plan” such that the area of the field spanning across the first height zone HZ1 is not treated with any agricultural products during execution of the treatment prescription.

It should be appreciated that, upon the development of a treatment prescription for the field F, the corresponding prescription may then be executed using one or more agricultural vehicles, such as the agricultural vehicle 108 described above with reference to FIG. 1. For instance, the prescription map PM may be transmitted to the vehicle 108 for display to the operator. In such an embodiment, the operator may then control the operation of the vehicle 108 to execute the appropriate treatment plan across each height zone within the field. Alternatively, when the agricultural vehicle 108 is configured for autonomous or semi-autonomous operation, the data associated with the prescription map PM may he transmitted to the vehicle 108 to allow the operation of the vehicle 108 to be automatically controlled in accordance with the treatment prescription. For example, when the agricultural vehicle corresponds to a sprayer, the amount of liquid fertilizer or other agricultural product being sprayed may he varied as the sprayer moves across the differing height zones to ensure that the amount of agricultural product applied by the sprayer within each height zone is consistent with the associated treatment plan.

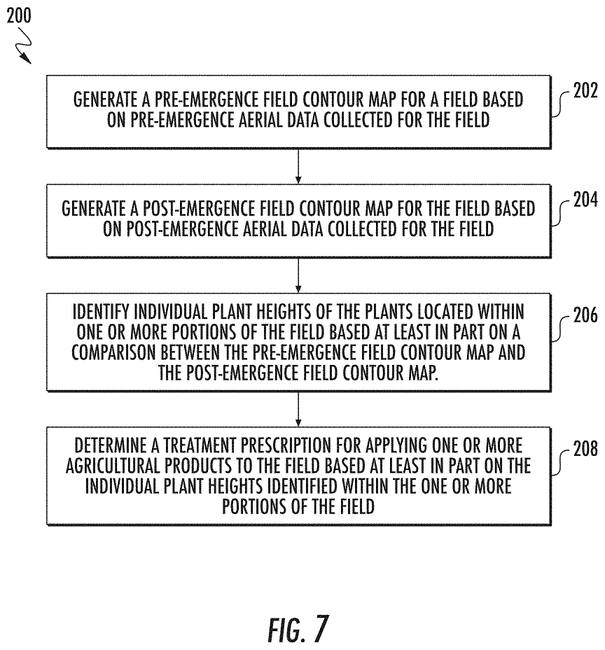

Referring now to FIG. 7, a flow diagram of one embodiment of a method 200 for generating agricultural treatment prescriptions is illustrated in accordance with aspects of the present subject matter. For purposes of discussion, the method 200 will generally be described herein with reference to the system 100 described above with reference to FIGS. 1 and 2. However, it should be appreciated that the disclosed method 200 may be executed in association with any suitable system having any other suitable system configuration. Additionally, although FIG. 7 depicts steps performed in a. particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (202) the method 200 may include generating a pre-emergence field contour map for a field based on pre-emergence aerial data collected for the field. As indicated above, a UAV 102 may be used to make one or more pre-emergence passes across a field to collect topology data indicative of the topology or height contour of the ground surface of the field prior to the emergence of plants within the field. Such pre-emergence topology data may then form the basis of a pre-emergence field contour map representing the ground surface topology across the entire field.

Additionally, at (204), the method 200 may include generating a post-emergence field contour map for the field based on post-emergence aerial data collected for the field. For instance, as indicated above, a UAV 102 may be used to make one or more post-emergence passes across a field to collect topology data indicative of the topology or height contour of the field following the emergence of plants within the field. Such post-emergence topology data may then form the basis of a post-emergence field contour map representing the field topology across the entire field.

Moreover, at (206), the method 200 may include identifying individual plant heights of the plants located within one or more portions of the field based at least in part on a comparison between the pre-emergence field contour map and the post-emergence field contour map. For example, as indicated above, a plant height profile for the field may be determined by calculating the differential between the pre-emergence field contour map and the post-emergence field contour map. In such an embodiment, by referencing or accessing planting data associated with field (e.g., geo-referenced planting data identifying the location of each plant within the field), the plant height profile may be analyzed to identify the height of each individual plant within the field.

Referring still to FIG. 7, at (208), the method 200 may include determining a treatment prescription for applying one or more agricultural products to the field based at least in part on the individual plant heights identified within the one or more portions of the field. Specifically, as indicated above, the plant height data may be analyzed to identify areas within the field that require treatment, such as plant height zones in which the plants exhibit shorter heights than in other areas within the field. A localized treatment plan may then be generated for applying one or more agricultural products to the identified areas within the field.

It is to be understood that the steps of the method 200 are performed by a controller(s) (e.g., controller(s) 110 and/or controller 106) upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller(s) described herein, such as the method 200, is implemented in software code or instructions which are tangibly stored on a tangible computer readable medium. The controller(s) loads the software code or instructions via a direct interface with the computer readable medium or via a wired and/or wireless network. Upon loading and executing such software code or instructions by the controller(s), the controller(s) may perform any of the functionality of the controller(s) described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for generating agricultural treatment prescriptions, the method comprising:
generating, with a computing device, a pre-emergence field contour map for a field based on pre-emergence aerial data collected for the field, the pre-emergence field contour map being indicative of a ground surface topology of the field while the field is in a pre-emergence condition;
generating, with the computing device, a post-emergence field contour map for the field based on post-emergence aerial data collected for the field, the post-emergence field contour map being indicative of a field topology of the field following emergence of plants within the field;
identifying, with the computing device, individual plant heights of the plants located within one or more portions of the field based at least in part on a comparison between the pre-emergence field contour map and the post-emergence field contour map; and
determining, with the computing device, a treatment prescription for applying one or more agricultural products to the field based at least in part on the individual plant heights identified within the one or more portions of the field.

2. The method of claim 1, further comprising determining a plant height profile across the field based on a comparison between the pre-emergence field contour map and the post-emergence field contour map.

3. The method of claim 2, wherein identifying the individual plant heights of the plants located within the one or more portions of the field comprises:
accessing planting data associated with locations of the plants within the field; and
identifying the individual plant heights of the plants located within the one or more portions of the field based on the plant height profile and the planting data.

4. The method of claim 3, wherein the planting data comprises a planting map including geo-referenced data identifying a location of each respective plant within the field.

5. The method of claim 1, wherein the one or more portions of the field comprises at least one first portion of the field and at least one second portion of the field, wherein the method further comprises:
identifying the at least one first portion of the field as an area of interest based on a difference between the individual plant heights of the plants within the at least one first portion of the field and the individual plant heights of the plants within the at least one second portion of the field.

6. The method of claim 5, wherein determining the treatment prescription for applying one or more agricultural products to the field comprises determining a localized treatment prescription for applying the one or more agricultural products to the at least one first portion of the field based on the individual plant heights of the plants within the at least one first portion of the field being less than the individual plant heights of the plants within the at least one second portion of the field.

7. The method of claim 1, wherein determining the treatment prescription for applying the one or more agricultural products to the field comprises determining a height-based treatment prescription for applying the one or more agricultural products to identified areas within the field in which the individual plant heights for the plants within the identified areas are less than the individual plants heights for the plants within other areas of the field.

8. The method of claim 1, further comprising transmitting the treatment prescription for the field to an agricultural vehicle configured to perform a treatment operation within the filed based on the treatment prescription.

9. The method of claim 1, further comprising receiving the pre-emergence aerial data and the post-emergence aerial data from a sensor supported on an unmanned aerial vehicle (UAV) that is configured to be flown across the field.

10. The method of claim 9, further comprising automatically controlling the operation of the MAV to perform one or more pre-emergence passes across the field to collect the pre-emergence aerial data with the sensor and one or more post-emergence passes across the field to collect the post-emergence aerial data with the sensor.

11. The method of claim 10, wherein automatically controlling the operation of the UAV to perform the one or more post-emergence passes comprises automatically controlling the operation of the UAV to periodically perform the one or more post-emergence passes across the field to collect a plurality of different sets of post-emergence aerial data, each set of post-emergence aerial data comprising topology data for the field at a different time during a growth cycle of the plants within the field.

12. The method of claim 9, wherein the sensor comprises a Light Detection and Ranging (LIDAR) device.

13. The method of claim 1, wherein:
generating the post-emergence field contour map for the field based on the post-emergence aerial data comprises:
generating a first post-emergence field contour map for the field based on a first set of post-emergence aerial data captured at a first time during a growth cycle of the plants within the field; and
generating a second post-emergence field contour map for the field based on a second set of post-emergence aerial data captured at a second first time during the growth cycle of the plants within the field, the second time differing from the first time; and
wherein the method further comprises:
determining a first plant height profile across the field based on a comparison between the pre-emergence field contour map and the first post-emergence field contour map, the first plant height profile being indicative of the height of the plants within the field relative to the ground surface topology at the first time during the growth cycle; and
determining a second plant height profile across the field based on a comparison between the pre-emergence field contour map and the second post-emergence field contour map, the second plant height profile being indicative of the height of the plants within the field relative to the ground surface topology at the second time during the growth cycle.

14. The method of claim 13, further comprising determining a growth rate of individual plants within the field based at least in part on a comparison between the first and second plant height profiles.

15. A crop management system, comprising:
one or more unmanned aerial vehicles (UAVs) equipped with a sensor configured to capture aerial-based topology data associated with a field, the one or more UAVs being configured to be flown across the field at differing times to allow the sensor to collect both pre-emergence topology data and post-emergence topology data for the field;
a controller configured to be communicatively coupled to the sensor, the controller being further configured to;
generate a pre-emergence field contour map for the field based on the pre-emergence topology data received from the sensor, the pre-emergence field contour map being indicative of a ground surface topology of the field while the field is in a pre-emergence condition;
generate a post-emergence field contour map for the field based on post-emergence topology data received from the sensor, the post-emergence field contour map being indicative of a field topology of the field following emergence of plants within the field;
identify individual plant heights of the plants located within one or more portions of the field based at least in part on a comparison between the pre-emergence field contour map and the post-emergence field contour map the plant height profile; and
determine a treatment prescription for applying one or more agricultural products to the field based at least in part on the individual plant heights identified within the one or more portions of the field.

16. The system of claim 15, wherein the sensor comprises a Light Detection and Ranging (LIDAR) device.

17. The system of claim 15, wherein the controller is configured to identify individual plant heights of the plants located within the one or more portions of the field based on both the comparison between the pre-emergence field contour map and the post-emergence field contour map the plant height profile and planting data associated with locations of the plants within the field.

18. The system of claim 15, wherein the one or more portions of the field comprises at least one first portion of the field and at least one second portion of the field, the controller being configured to identify the at least one first portion of the field as an area of interest based on a difference between the individual plant heights of the plants within the at least one first portion of the field and the individual plant heights of the plants within the at least one second portion of the field.

19. The system of claim 18, wherein the controller is configured to determine a localized treatment prescription for applying the one or more agricultural products to the at least one first portion of the field based on the individual plant heights of the plants within the at least one first portion of the field being less than the individual plant heights of the plants within the at least one second portion of the field.

20. The system of claim 15, wherein the controller is further configured to automatically control the operation of the UAV to perform one or more pre-emergence passes across the field to collect the pre-emergence aerial data with the sensor and one or more post-emergence passes across the field to collect the post-emergence aerial data with the sensor.
